(19) United States
(12) Patent Application Publication
(10) Pub. No.: US 2025/0341964 A1
(43) Pub. Date: Nov. 6, 2025

(54) SOLID-STATE DRIVES WITH COMPRESSION-ENABLED DYNAMIC MULTI-BIT PER CELL CONFIGURATION

(71) Applicant: ScaleFlux, Inc., San Jose, CA (US)

(72) Inventors: Tong Zhang, Albany, NY (US); Jiangpeng Li, San Jose, CA (US); Yang Liu, Milpitas, CA (US); Fei Sun, Irvine, CA (US)

(21) Appl. No.: 18/655,649

(22) Filed: May 6, 2024

(51) Int. Cl. G06F 3/06

(52) U.S. Cl. CPC G06F 3/0608; G06F 3/064; G06F 3/0679

(57) ABSTRACT

A system and method for method of implementing a solid-state drive (SSD). A method includes: providing a plurality of flash memory chips (flash memory) addressable via physical block addresses (PBAs) and a controller chip that maps logical block addresses (LBAs) to PBAs and includes in-storage transparent compression; exposing an LBA storage space to equal the PBA storage space of the flash memory; compressing data using in-storage transparent compression to generate compressed data; configuring different portions of the flash memory to operate in different bit/cell modes; and storing a first part of the compressed data in a first portion of flash memory having a first bit/cell mode, and storing a second part of the compressed data in a second portion of flash memory have a second bit/cell mode.

### TECHNICAL FIELD

The present invention relates to the field of solid-state drives (SSD), and particularly to SSDs that more effectively serve applications via built-in transparent compression.

### BACKGROUND

Solid-state drives (SSDs), which use non-volatile NAND flash memory technology, are being pervasively deployed in numerous computing and storage systems. In addition to one or multiple NAND flash memory chips, each SSD must contain a controller chip that manages all the NAND flash memory chips. Within each NAND flash memory chip, all the memory cells are organized in an “array→block→page” hierarchy, where one NAND flash memory array consists of a large number (e.g., thousands) of blocks, and each block contains a certain number (e.g., 256) of pages. The size of each flash memory page typically ranges from 8 KiB to 32 KiB, and the size of each flash memory block is typically tens of MBs. NAND flash memory can store one or multiple bits per memory cell, representing a trade-off between speed/endurance and cost: As each memory cell stores more bits to reduce the effective NAND flash memory bit cost, NAND flash memory will have smaller operational noise margin that leads to lower read/write speed and shorter endurance lifetime. Modern NAND flash memory supports four different multi-bit per cell configurations: SLC (1 bit/cell), MLC (2 bits/cell), TLC (3 bits/cell) and QLC (4 bits/cell).

Recent years witnessed the significant growth of high-value AI-oriented applications that involve a huge amount of active working data set (e.g., hundreds of GB and multiple TBs) and meanwhile are dominated by moderate-size data access (e.g., 256 B or 400 B per data access). For such applications, hybrid-DRAM/SSD memory hierarchy can be much more cost-effective than DRAM-only memory. Compared with most other applications, such high-value AI-oriented applications have much more stringent demands on SSD data access latency and IOPS performance.

To exploit runtime data compressibility, SSDs could integrate transparent compression capability: Each LBA data block is compressed individually to reduce the data footprint and meanwhile avoid degrading SSD IOPS (I/O per second) performance. Inside SSDs, all the variable-length compressed LBA data blocks are packed and stored on NAND flash memory chips. To materialize the benefit of intra-SSD compression, SSD could expose an expanded LBA storage space that is larger than its internal physical flash memory storage space, e.g., an SSD with 4 TB physical flash memory storage space could expose 8 TB LBA storage space to the host. Due to the unpredictable and dynamically varying runtime data compressibility, host must closely monitor the runtime LBA and physical storage space usage to avoid out-of-physical-space error.

### SUMMARY

Aspects of this disclosure provide a system and method for implementing an SSD that utilizes in-storage transparent compression to facilitate storage of data into different bit/cell modes.

A first aspect of the disclosure provides a solid-state drive (SSD), comprising: a plurality of flash memory chips (flash memory) addressable via physical block addresses (PBAs); and a controller chip that maps logical block addresses (LBAs) to PBAs and includes in-storage transparent compression, wherein the controller chip implements a process that includes: exposing an LBA storage space to equal the PBA storage space of the flash memory; compressing data using in-storage transparent compression to generate compressed data; configuring different portions of the flash memory to operate in different bit/cell modes; and storing a first part of the compressed data in a first portion of flash memory having a first bit/cell mode, and storing a second part of the compressed data in a second portion of flash memory have a second bit/cell mode.

A second aspect of the disclosure provides a method for implementing an SSD, including: providing a plurality of flash memory chips (flash memory) addressable via physical block addresses (PBAs) and a controller chip that maps logical block addresses (LBAs) to PBAs and includes in-storage transparent compression; exposing an LBA storage space to equal the PBA storage space of the flash memory; compressing data using in-storage transparent compression to generate compressed data; configuring different portions of the flash memory to operate in different bit/cell modes; and storing a first part of the compressed data in a first portion of flash memory having a first bit/cell mode, and storing a second part of the compressed data in a second portion of flash memory have a second bit/cell mode.

Other aspects of the disclosure include any of the prior aspects, wherein the first portion of flash memory has a smaller number of bits per cell than the second portion of flash memory, and wherein compressed data is assigned to one of the first and second portions of flash memory based on an importance factor and/or compressibility.

The illustrative aspects of the present disclosure are designed to solve the problems herein described and/or other problems not discussed.

### BRIEF DESCRIPTION OF THE DRAWINGS

These and other features of this disclosure will be more readily understood from the following detailed description of the various aspects of the disclosure taken in conjunction with the accompanying drawings that depict various embodiments of the disclosure, in which:

FIG. 1 depicts an SSD memory system, in accordance with an illustrative embodiment.

FIG. 2 illustrates the partitioning of a multi-mode SSD's LBA space into multiple partitions with different LBA block size, in accordance with an illustrative embodiment.

FIG. 3 illustrates a compression-capable SSD exposing an expanded LBA storage space.

FIG. 4 illustrates a compression-capable SSD exposing an unexpanded LBA storage space, in accordance with an illustrative embodiment.

FIG. 5 illustrates the use of intra-SSD transparent compression to improve speed and performance for a portion of data, in accordance with an illustrative embodiment.

FIG. 6 illustrates the grouping of multiple consecutive LBAs into one LBA segment, in accordance with an illustrative embodiment.

FIG. 7 illustrates a flow diagram of updating counters associated LBA segments in all the partitions, in accordance with an illustrative embodiment.

FIG. 8 illustrates a flow diagram of assigning LBA segments to superblocks with different multi-bit per cell configurations, in accordance with an illustrative embodiment.

FIG. 9 illustrates an operational flow diagram of storing LBA blocks into open superblocks with different multi-bit per cell modes, in accordance with an illustrative embodiment.

FIG. 10 illustrates a proposed application page content re-organization to make per-LBA compression ratio more uniform, in accordance with an illustrative embodiment.

The drawings are intended to depict only typical aspects of the disclosure, and therefore should not be considered as limiting the scope of the disclosure.

### DETAILED DESCRIPTION OF THE DISCLOSURE

Embodiments of the disclosure provide technical solutions for a solid-state drive (SSD) infrastructure that more effectively serves applications via built-in transparent compression. Aspects of the present invention take advantage of built-in transparent compression to dynamically allocate and store data into different bit per cell configurations (i.e., modes) based on determined importance of the data.

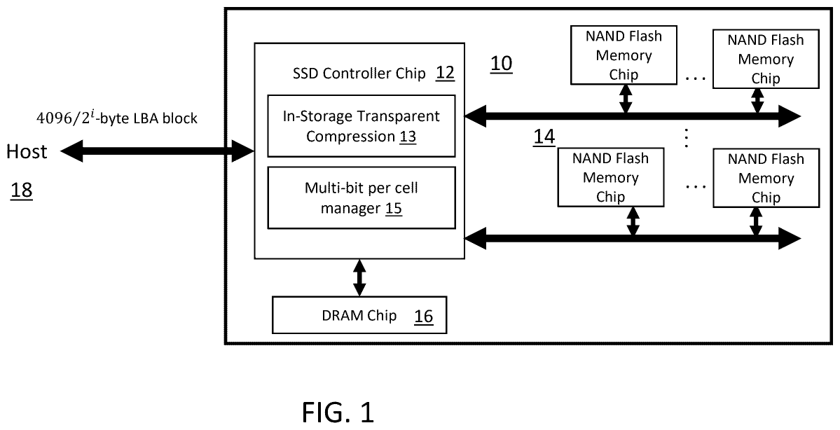

FIG. 1 illustrates the modern architecture of an SSD 10. SSD 10 generally includes a controller chip 12, multiple NAND memory chips (flash memory) 14 organized over multiple channels, and one (or a few) DRAM chips 16. An SSD exposes an array of logical block addresses (LBAs), each LBA associates with Bᵢ=4096/2ⁱ bytes of storage space. For example, when i is 0 or 3, each LBA will associate with B₀=4096 bytes or B=512 bytes. The value of i is determined when SSDs are being formatted by the host 18. In this illustrative embodiment, SSD 10 also includes: (1) in-storage transparent compression 13 that provides intra-SSD transparent compression, described in further detail herein, and (2) a multi-bit per cell manager 15 that can configure NAND memory chips 14 into multiple different bit/cell arrangements and determine how to store data therein.

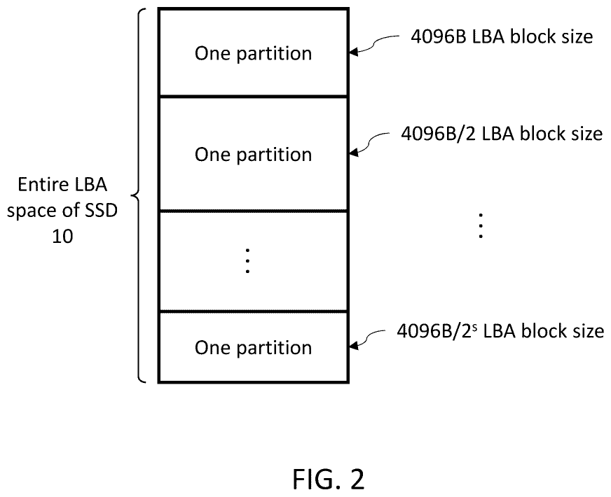

Recent years witnessed the significant growth of high-value AI-oriented applications that involve a huge amount of active working data set (e.g., hundreds of GBs and multiple TBs) and meanwhile are dominated by moderate-size data access (e.g., 256 B or 400 B per data access). For such applications, storing their huge amount of active working data set over a hybrid-DRAM/SSD memory hierarchy can be much more cost-effective than using DRAM-only memory. SSD I/O interface protocols (e.g., NVMe) allow the host 18 to partition/format SSDs so that different partitions have different LBA block sizes (e.g., 512 B or 4096 B). An example of this is shown in FIG. 2.

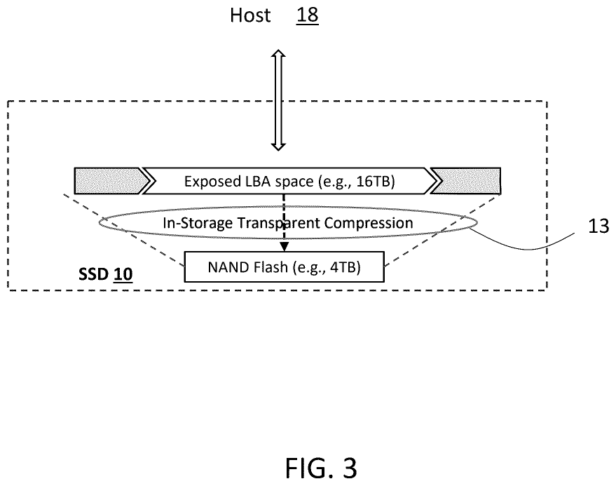

Furthermore, to exploit the runtime data compressibility, SSDs can integrate in-storage transparent compression 13, as shown in FIG. 3. To avoid affecting the input/output operations per second (IOPS) performance, SSDs can compress LBA data blocks individually, i.e., for each partition, compress its each Bᵢ-byte LBA data block independently from the other LBA data blocks. To materialize the benefit of intra-SSD compression, the SSD 10 could expose an expanded LBA storage space that is larger than its internal physical flash memory storage space, e.g., an SSD with 4 TB physical flash memory storage capacity could expose a 16 TB LBA storage space to the host. Due to the unpredictable and dynamically varying runtime data compressibility, host 18 must closely monitor the runtime physical storage space usage to avoid an out-of-physical-space error. This however adds complexity to the host-side software stack design and operation.

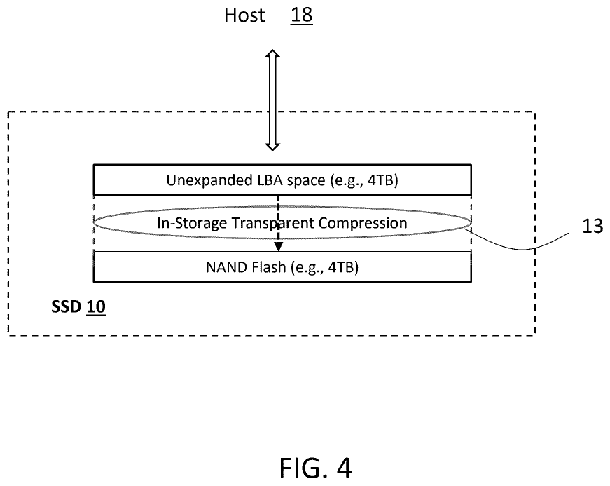

As shown in FIG. 4, the present approach configures a compression-capable SSD 10 to not expose an expanded LBA storage space, i.e., like ordinary SSDs, the compression-capable SSD 10 exposes an LBA storage space that equals to their internal physical flash memory storage capacity. Using this approach, the present approach allows SSD 10 to implement multiple different bit per cell configurations. (In prior practice, all the NAND flash memory cells inside SSDs operate under the same multi-bit per cell configuration, denoted as l bits/cell.) This present approach allows host 18 to seamlessly benefit from intra-SSD transparent compression, without additional host-side complexity.

In the present approach, intra-SSD transparent compression is still utilized to compress data from host 18. Once intra-SSD transparent compression reduces the data footprint, the SSD 10 can utilize multi-bit per cell manager 15 (FIG. 1) to configure some NAND flash memory cells to operate under k<l bits/cell to improve the speed performance while still ensuring the same total LBA storage capacity.

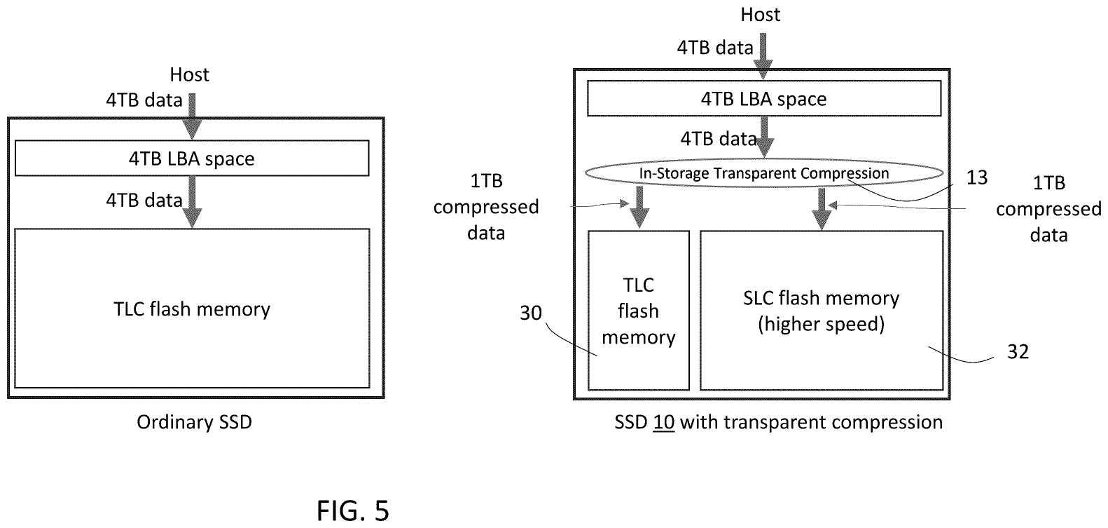

For example, as shown in the left side of FIG. 5, in the absence of transparent compression, a total of 4 TB of uncompressed data could be stored into an ordinary SSD in which all the NAND flash memory cells operate in the TLC (i.e., 3 bits cell) mode. Suppose all the LBA data blocks have the same compression ratio of 2:1, then the 4 TB data can be compressed into 2 TB.

As shown on the right-hand side of FIG. 5, without expanding its LBA storage space, SSD 10 with in-storage transparent compression 13 still exposes a 4 TB LBA storage space (i.e., users can only store a total 4 TB data into the SSD 10). However, after internally compressing 4 TB user data to 2 TB, SSD 10 can configure 75% of its NAND flash memory cells to operate in the SLC mode (i.e., 1 bit/cell) 32 and leave the rest 25% of NAND flash memory cells to remain in the TLC mode 30. Accordingly, out of the total 2 TB compressed data, SSD 10 stores 1 TB of compressed data on 25% of NAND flash memory cells that operate in the TLC mode 30, and stores the other 1 TB of compressed data on 75% of NAND flash memory cells that operate in the SLC mode 32. From the user's perspective, SSD 10 stores a total of 4 TB of uncompressed user data (i.e., without LBA space expansion), internally the SSD stores 1 TB compressed data (2 TB original user data) on SLC NAND flash memory that have better speed performance than TLC NAND flash memory. Without LBA space expansion (hence without complicating the host-side software stack), SSD 10 utilizes its internal transparent compression to opportunistically improve the speed performance for a certain portion of data.

Two illustrative design strategies are provided to practically implement the design principle of leveraging transparent compression to improve speed performance without LBA space expansion. These two strategies are orthogonal and can be readily combined. Other approaches not detailed herein could likewise be utilized.

The objective of the first design strategy is to store data that is more performance-critical on flash memory cells with smaller number of bits per cell, in adaptation to runtime data compressibility. The realization of this design strategy faces two issues: (1) how to identify the data that are more performance-critical, and (2) how to adjust multi-bit per cell configurations for different portions of data. This following illustrative techniques address these two issues.

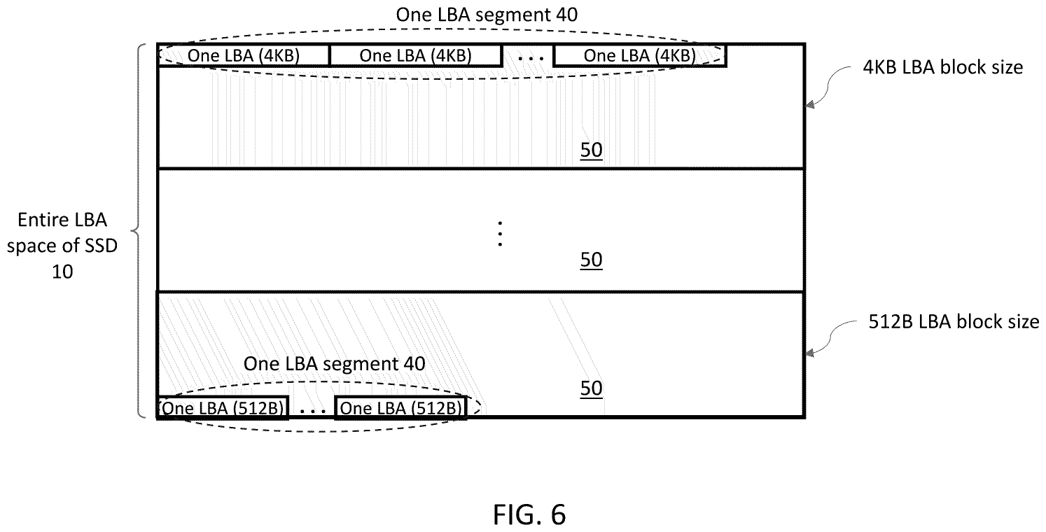

To identify the data that are more performance-critical, the following technique may be utilized. First, as shown in FIG. 6, since SSD 10 memory partitions 50 with a smaller LBA block size more likely store performance-critical data, SSD 10 assigns different importance factors to partitions 50 with distinct LBA block sizes. Suppose SSD 10 supports a total of M+1 different LBA block sizes, denoted as B₀, B₁, . . . , B_{M}, where Bᵢ=4096/2. SSD partitions 50 with LBA block size of Bᵢ=4096/2 are referred to as type-Bᵢ partitions. SSD 10 assigns an importance factor sᵢ to type-Bᵢ partition, where s₀<s₁< . . . <s_{M} (i.e., the partitions with a smaller LBA block size are assigned with a higher importance factor). Meanwhile, for each type-Bᵢ SSD partition 50, we further assign every group of nᵢ consecutive LBA blocks into an LBA segment 40, where n₀>n₁> . . . >n_{M} (i.e., the partitions with smaller LBA block size have smaller segment sizes). During the runtime, SSD 10 internally keeps track of the data access intensity γ over each LBA segment 40 in all the partitions 50. The more frequently LBA blocks within one LBA segment 40 are accessed, the higher the data access intensity of this LBA segment will be. Since the data access characteristics tend to vary over the time, SSD 10 can periodically update the value of data access intensity γ of all the LBA segments 40.

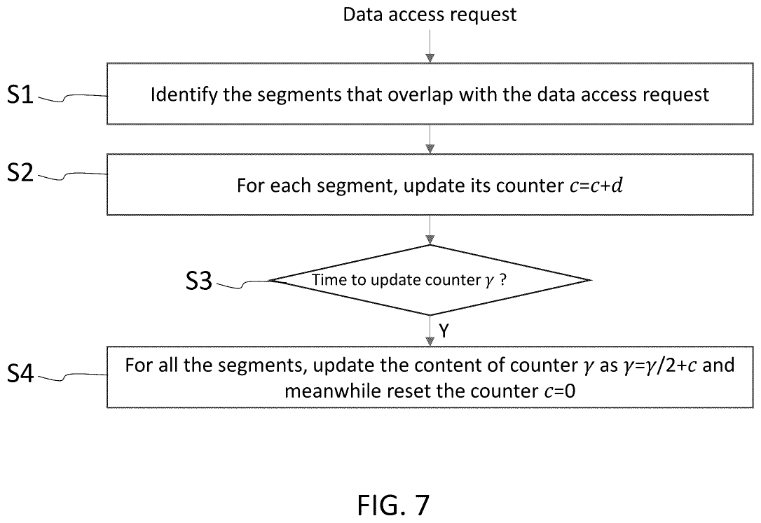

FIG. 7 illustrates the flow diagram of one possible approach to realize such periodic update: For each LBA segment of all the partitions, SSD 10 internally maintains two counters c and γ. The counter γ stores the value of current data access intensity. Each time when d LBA blocks on one LBA segment are accessed (i.e., performs a data access request), SSD 10 identifies the segment 40 that overlap with the data access request at S1, and updates the counter c=c+d at S2. Periodically (e.g., based on time or some other factor at S3), for all the LBA segments, SSD 10 updates the content of counter γ as

$$γ = \frac{γ}{2} + c$$

and meanwhile resets the counter c=0 at S4. Accordingly, in this example, SSD 10 internally uses a parameter β=sᵢ·γ≥0 to quantify the runtime importance of each LBA segment in all the partitions.

Assume NAND flash memory cells could be configured to operate in l different multi-bit per cell modes: 1 bit/cell, 2 bits/cell, . . . , l bits/cell. Based on the runtime importance parameter β of each LBA segment, SSDs categorize all the LBA segments into l zones using l+1 thresholds: T₀=∞>T₁>T₂> . . . >T₁₋₁>Tₗ=0. For LBA segments whose runtime importance parameter (falls into (Tᵢ₋₁, Tᵢ), they will be categorized into the zone Zᵢ. In this approach, LBA segments in Zᵢ are more important (i.e., more performance-critical) than LBA segments in Zⱼ for any i<j.

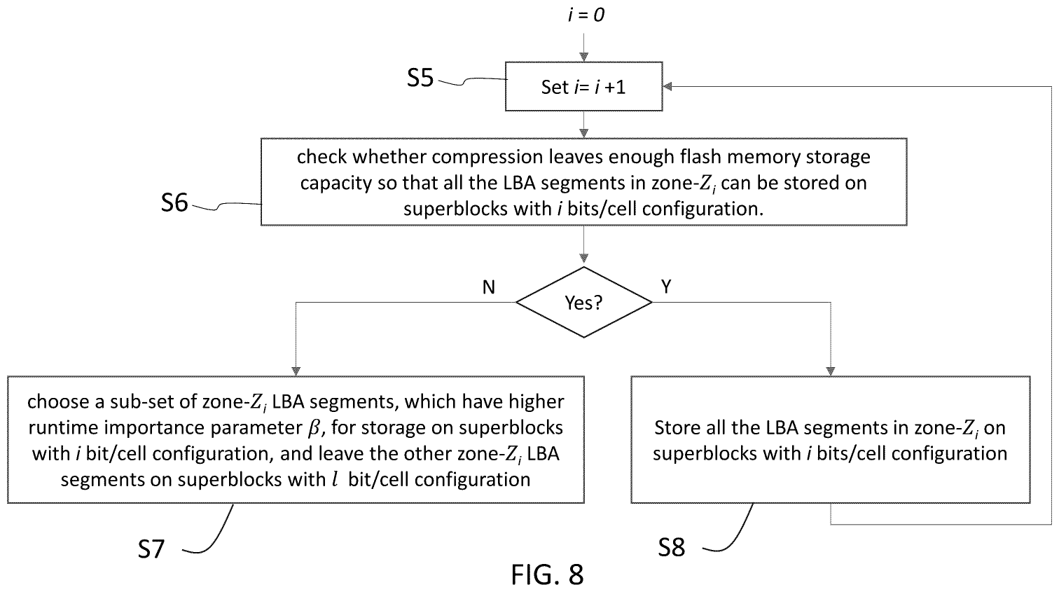

All the NAND flash memory cells inside one SSD 10 are grouped into a large number of superblocks, and all the cells inside one superblock are erased altogether and should operate in the same multi-bit per cell mode. During runtime, in adaptation to the overall data compression ratio, SSD 10 determines the configuration of flash memory multi-bit per cell mode for zone-Z; as shown in FIG. 8. At S5, starting from zone-Z₁ (i.e., the zone contains LBA segments with the highest runtime importance parameter β), SSD 10 checks at S6 whether compression leaves enough flash memory storage capacity so that all the LBA segments in zone-Z₁ can be stored on superblocks with a 1 bit/cell configuration. If not, at S7, SSD 10 chooses a sub-set of zone-Z₁ LBA segments, which have higher runtime importance parameter, for storage on superblocks with 1 bit/cell configuration, and leaves the other zone-Z₁ LBA segments on superblocks with l bit/cell configuration. As shown at S8, if the overall data compression ratio is good enough so that all the zone-Z₁ LBA segments can be stored on superblocks with 1 bit/cell configuration, SSD 10 further checks the zone-Z₂ LBA segments and so on. Under sufficient data compression ratio, all the zone-Zᵢ LBA segments can be stored on superblocks with i bits/cell configuration. In response to the runtime variation of data compressibility and segment importance, SSD 10 must dynamically adjust the mapping between segments and zones, and accordingly readjust the storage of segments in different zones.

The second design strategy aims to opportunistically configure a portion of flash memory cells into a higher speed mode (e.g., a smaller number of bits per cell) to better serve data that is more compressible. Let δ≥1 denote the compression ratio of each LBA data block, which is defined as the ratio between the LBA block size and compressed block size. For example, assume one 4 KB LBA data block size compressed into 1 KB, its compression ratio is 4 KB/1 KB=4. The more compressible one LBA data block is, the larger the compression ratio δ is. Assume NAND flash memory cells can be configured to operate in l different multi-bit per cell modes: 1 bit/cell, 2 bits/cell, . . . , l bits/cell. During the runtime, SSD 10 keeps l superblocks open to store new incoming data, where the i-th superblock operates in the i bits/cell mode for 1≤i≤l. Define l+1 thresholds: H₀=∞,

$${H}_{i} = \frac{l}{i} , 1 \leq i \leq l .$$

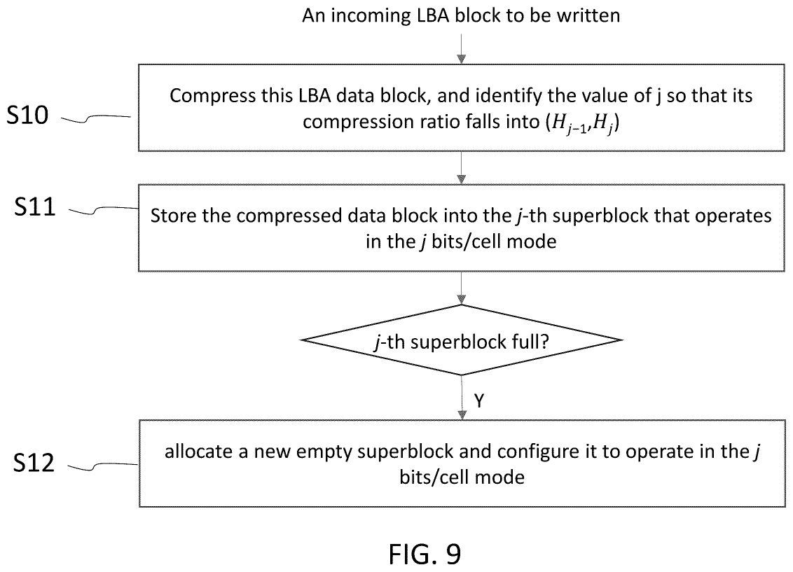

As shown in FIG. 9, for each incoming LBA block to be written, if its compression ratio δ falls into (Hⱼ₋₁, Hⱼ) at S10, the compressed LBA data block will be stored into the j-th superblock that operates in the j bits/cell mode at S11. Once a superblock is full, at S12 SSD 10 will seal it and allocate a new empty superblock and configure it into the same multi-bit per cell mode as the sealed one. In this way, being stored in flash memory cells with smaller number of bits per cell, LBA blocks with higher compression ratio can be read with a higher speed.

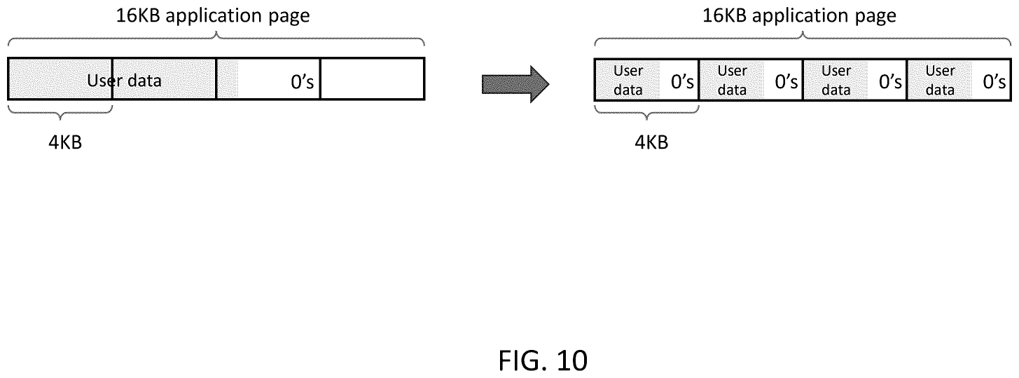

One issue with this design strategy is that adjacent LBA blocks may be stored in different superblocks if they have largely different compression ratio. This is undesirable for applications that tend to simultaneously access multiple adjacent LBA blocks, e.g., most relational databases access data in the unit of 8 KB or 16 KB pages, while LBA block size is 4 KB or less. To improve the probability that adjacent LBA blocks have similar compression ratio and hence are stored together in the same superblock, applications could perform intra-page data re-organization. As shown in the left side of FIG. 10, with a multi-4 KB page size, applications typically fill data into pages from one end to the other, and leaves an unfilled portion as all-zero. Since all-zero content can be highly compressed, within one multi-4 KB page, tail LBA blocks tend to have much higher compressibility than head LBA blocks. To make per-LBA-block compression ratio more uniform within one page, applications could re-distribute all-zero content among all the 4 KB LBA blocks in a more uniform manner, as shown in the right side of FIG. 10. This will help to improve the likelihood that adjacent LBA blocks in the same page are stored together in the same superblock.

It is understood that aspects of the present disclosure may be implemented in any manner, e.g., as a software/firmware program, an integrated circuit board, a controller card, etc., that includes a processing core, I/O, memory and processing logic. Aspects may be implemented in hardware or software, or a combination thereof. For example, aspects of the processing logic may be implemented using field programmable gate arrays (FPGAs), application specific integrated circuit (ASIC) devices, and/or other hardware-oriented systems.

Aspects also may be implemented with a computer program product stored on a computer readable storage medium. The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random-access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, etc. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Python, Smalltalk, C++ or the like, and conventional procedural programming languages, such as the “C” programming language or similar programming languages. The computer readable program instructions may execute entirely on a host computer, partly on a host computer, on a remote computing device (e.g., a memory card) or entirely on the remote computing device. In the latter scenario, the remote computing device may be connected to the host computer through any type of interface or network. In some embodiments, electronic circuitry including, for example, programmable logic circuitry, field-programmable gate arrays (FPGA), or programmable logic arrays (PLA) may execute the computer readable program instructions by utilizing state information of the computer readable program instructions to control electronic circuitry in order to perform aspects of the present disclosure.

Computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. The computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by hardware and/or computer readable program instructions.

The flowcharts and block diagrams in the figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The foregoing description of various aspects of the present disclosure has been presented for purposes of illustration and description. It is not intended to be exhaustive or to limit the concepts disclosed herein to the precise form disclosed, and obviously, many modifications and variations are possible. Such modifications and variations that may be apparent to an individual in the art are included within the scope of the present disclosure as defined by the accompanying claims.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various embodiments with various modifications as are suited to the particular use contemplated.

What is claimed is:

1. A solid-state drive (SSD), comprising:
a plurality of flash memory chips (flash memory) addressable via physical block addresses (PBAs); and
a controller chip that maps logical block addresses (LBAs) to PBAs and includes in-storage transparent compression, wherein the controller chip implements a process that includes:
exposing an LBA storage space to equal the PBA storage space of the flash memory;
compressing data using in-storage transparent compression to generate compressed data;
storing compressed data in LBA segments, each containing a set of consecutive LBA blocks;
categorizing LBA segments based on an importance factor;
dedicating different portions of the flash memory to operate in different bit/cell modes; and
storing LBA segments in different portions of flash memory based on the importance factor of each LBA segment.

2. The SSD of claim 1, wherein a first bit/cell mode comprises triple-level cell (TLC) storage, and a second bit/cell mode comprises single-level cell (SLC) storage.

3. The SSD of claim 1, wherein the flash memory is formatted into a plurality of partitions for storing LBA segments, wherein each partition is configured to store a different LBA block size, and wherein the importance factor for each LBA segment is based on the partition that stores the LBA segment.

4. The SSD of claim 3, wherein the different portions of flash memory comprise a plurality of superblocks, and wherein each superblock has a corresponding bit/cell mode.

5. The SSD of claim 4, wherein the importance factor is further based on data access intensity of data within the data segment over a period of time.

6. The SSD of claim 5, wherein LBA segments are periodically assigned to different superblocks based on a recalculated importance factor for the LBA segments.

7.-10. (canceled)

11. A method of implementing a solid-state drive (SSD), comprising:
providing a plurality of flash memory chips (flash memory) addressable via physical block addresses (PBAs) and a controller chip that maps logical block addresses (LBAs) to PBAs and includes in-storage transparent compression;
exposing an LBA storage space to equal the PBA storage space of the flash memory;
compressing data using in-storage transparent compression to generate compressed data;
storing compressed data in LBA segments, each containing a set of consecutive LBA blocks;
categorizing LBA segments based on an importance factor;
dedicating different portions of the flash memory to operate in different bit/cell modes; and
storing LBA segments in different portions of flash memory based on the importance factor of each LBA segment.

12. The method of claim 11, wherein a first bit/cell mode comprises triple-level cell (TLC) storage, and a second bit/cell mode comprises single-level cell (SLC) storage.

13. The method of claim 11, wherein the flash memory is formatted into a plurality of partitions for storing LBA segment, wherein each partition is configured to store a different LBA block size, and wherein the importance factor for an LBA segment is based on the partition that stores the LBA segment.

14. The method of claim 13, wherein the different portions comprise a plurality of superblocks, and wherein each superblock has a corresponding bit/cell mode.

15. The method of claim 14, wherein the importance factor is further based on data access intensity of data within the data segment over a period of time.

16. The method of claim 15, wherein LBA segments are periodically assigned to different superblocks based on a recalculated importance factor for the LBA segments.

17.-20. (canceled)

21. A solid-state drive (SSD), comprising:
a plurality of flash memory chips (flash memory) addressable via physical block addresses (PBAs); and
a controller chip that maps logical block addresses (LBAs) to PBAs and includes in-storage transparent compression, wherein the controller chip implements a process that includes:
exposing an LBA storage space to equal the PBA storage space of the flash memory;
dedicating different portions of the flash memory to operate in different bit/cell modes;
receiving a data block;
compressing the data block using in-storage transparent compression to generate a compressed data block;
calculating a compression ratio of the data block; and
storing the compressed data block in one of the different portions of flash memory based on the compression ratio.

22. The SSD of claim 21, wherein the different portions comprise different superblocks.

23. The SSD of claim 22, further comprising determining whether the compressed data block will fit into a targeted superblock, and if not, allocating a new superblock.

24. The SSD of claim 21, wherein all-zero content within the superblock is redistributed.
